(19) United States
(12) Patent Application Publication
(10) Pub. No.: US 2017/0192742 A1
(43) Pub. Date: Jul. 6, 2017

(54) Player Interaction Method and Apparatus, and Storage Medium

(71) Applicant: ZTE CORPORATION, Shenzhen City, Guangdong Proving (CN)

(72) Inventor: Feng WANG, Shenzhen (CN)

(21) Appl. No.: 15/321,731

(22) PCT Filed: Oct. 9, 2014
(86) PCT No.: PCT/CN2014/088221

§ 371 Date: Mar. 9, 2017

(30) Foreign Application Priority Data
Jun. 26, 2014 (CN) 201410295508.9

(51) Int. Cl. G06F 3/16; G06F 3/01; G06F 3/03

(52) U.S. Cl. CPC G06F 3/165; G06F 3/03; G06F 3/017

(57) ABSTRACT

An interaction method and device for a player and a storage medium are disclosed. The method is applied to a terminal installed with the player, and includes that: the terminal sends a measurement signal (S101) to a measured object; the terminal receives an echo signal (S102); the terminal acquires a characteristic of the echo signal, and determines a player control instruction corresponding to the characteristic of the echo signal according to a preset corresponding relationship between the characteristic of the echo signal and the player control instruction (S103); and the terminal controls the player according to the player control instruction (S104).

### TECHNICAL FIELD

The present disclosure relates to a media file playing technology, and more particularly to an interaction method and device for a player and a storage medium.

### BACKGROUND

Along with development of a technology such as the Internet, multimedia resources such as videos, audios and pictures are increasingly enriched, and watching a multimedia resource through a player becomes a necessary manner.

At present, during interaction between a user and a player, a volume of the player or pause or start of the player is controlled by manually operating a medium such as a mouse, a touch screen and a remote controller, which causes an incapability of controlling the player when the user has no time for manual operation control in some emergency circumstances.

### SUMMARY

In order to solve the abovementioned problem, an embodiment of the present disclosure is intended to provide an interaction method and device for a player and a storage medium, which may implement control over a playing state of the player without manual operation.

The technical solutions of the present disclosure are implemented as follows.

On a first aspect, an embodiment of the present disclosure provides an interaction method for a player, which is applied to a terminal installed with the player, the method including that:

the terminal sends a measurement signal to a measured object;

the terminal receives an echo signal, herein the echo signal is a signal obtained after the measurement signal is reflected by the measured object;

the terminal acquires a characteristic of the echo signal, and determines a player control instruction corresponding to the characteristic of the echo signal according to a preset corresponding relationship between the characteristic of the echo signal and the player control instruction; and

the terminal controls the player according to the player control instruction.

According to a first possible implementation mode, with reference to the first aspect, the characteristic of the echo signal includes at least one of following attributes: strength of the echo signal and a frequency of the echo signal.

According to a second possible implementation mode, with reference to the first possible implementation mode, when the characteristic of the echo signal is the strength of the echo signal, the step that the player control instruction corresponding to the characteristic of the echo signal is determined according to the preset corresponding relationship between the characteristic of the echo signal and the player control instruction includes that:

when the strength of the echo signal changes, the terminal determines a distance state between the measured object and the terminal according to a change of the strength of the echo signal; and

a player control instruction corresponding to the distance state is determined according to the distance state between the measured object and the terminal and a preset corresponding relationship between the distance state and the player control instruction.

According to a third possible implementation mode, with reference to the first possible implementation mode, when the characteristic of the echo signal is the frequency of the echo signal, the step that the player control instruction corresponding to the characteristic of the echo signal is determined according to the preset corresponding relationship between the characteristic of the echo signal and the player control instruction includes that:

the terminal determines a movement trajectory of the measured object according to a deviation between the frequency of the echo signal and a frequency of the measurement signal in combination with a Doppler effect; and

the terminal determines a player control instruction corresponding to the movement trajectory of the measured object according to the movement trajectory of the measured object and a preset corresponding relationship between the movement trajectory and the player control instruction.

On a second aspect, an embodiment of the present disclosure provides an interaction device for a player, which is applied to a terminal installed with the player, the device including: a sending unit, a receiving unit, a characteristic acquisition unit, a determination unit and an instruction execution unit, herein:

the sending unit sends a measurement signal to a measured object;

the receiving unit receives an echo signal, herein the echo signal is a signal obtained after the measurement signal is reflected by the measured object;

the characteristic acquisition unit acquires a characteristic of the echo signal;

the determination unit determines a player control instruction corresponding to the characteristic of the echo signal according to a preset corresponding relationship between the characteristic of the echo signal acquired by the characteristic acquisition unit and the player control instruction; and

the instruction execution unit controls the player according to the player control instruction.

According to a first possible implementation mode, with reference to the second aspect, the characteristic of the echo signal includes at least one of following attributes: strength of the echo signal and a frequency of the echo signal.

According to a second possible implementation mode, with reference to the first possible implementation mode, when the characteristic of the echo signal is the strength of the echo signal,

the characteristic acquisition unit, when the strength of the echo signal changes, determines a distance state between the measured object and the terminal according to a change of the strength of the echo signal; and

the determination unit determines a player control instruction corresponding to the distance state according to the distance state between the measured object and the terminal and a preset corresponding relationship between the distance state and the player control instruction.

According to a third possible implementation mode, with reference to the first possible implementation mode, when the characteristic of the echo signal is the frequency of the echo signal,

the characteristic acquisition unit determines a movement trajectory of the measured object according to a deviation between the frequency of the echo signal and a frequency of the measurement signal in combination with a Doppler effect; and

the determination unit determine a player control instruction corresponding to the movement trajectory of the measured object according to the movement trajectory of the measured object and a preset corresponding relationship between the movement trajectory and the player control instruction.

On a third aspect, an embodiment of the present disclosure provides a terminal, which is installed with a player and includes the abovementioned interaction device for the player.

An embodiment of the present disclosure further provides a storage medium, in which a computer program is stored, herein the computer program executes the abovementioned interaction method for the player.

According to the interaction method and device for the player provided by the embodiment of the present disclosure, a behavior action of the measured object is captured, and a playing state of the player is automatically controlled according to the behavior action of the measured object, so that the playing state of the player may be controlled without manual operation.

### BRIEF DESCRIPTION OF DRAWINGS

FIG. 1 is a flowchart of an interaction method for a player according to an embodiment of the present disclosure;

FIG. 2 is a detailed flowchart of an interaction method for a player according to an embodiment of the present disclosure;

FIG. 3 is another detailed flowchart of an interaction method for a player according to an embodiment of the present disclosure;

FIG. 4 is another detailed flowchart of an interaction method for a player according to an embodiment of the present disclosure;

FIG. 5 is a structure diagram of an interaction device for a player according to an embodiment of the present disclosure; and

FIG. 6 is a structure diagram of a terminal according to an embodiment of the present disclosure.

### DETAILED DESCRIPTION

The technical solutions in the embodiment of the present disclosure will be clearly and completely described below with reference to the drawings in the embodiment of the present disclosure.

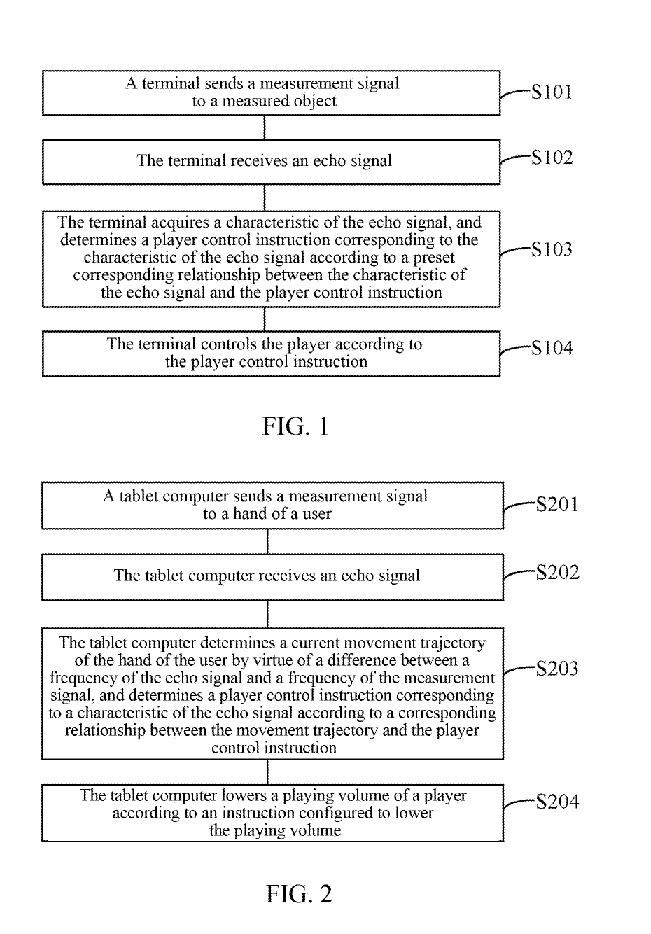

FIG. 1 shows a flow of an interaction method for a player according to an embodiment of the. It is important to note that the method is applied to a terminal installed with the player in the interaction method for the player according to the embodiment, the terminal may exemplarily be, not limited to, a Personal Computer (PC), a notebook computer, a smart phone, a tablet computer, a palmtop computer, an E-book reader, a Personal Digital Assistant (PDA), a Point of Sale (POS), an onboard computer, a Moving Picture Experts Group Audio Layer III (MP3) player, a Moving Picture Experts Group Audio Layer IV (MP4) player, a Mobile Internet Device (MID), a Digital Media Player (DMP) and the like, and the method may include the following steps: step 101, step 102, step 103 and step 104.

In step 101: the terminal sends a measurement signal to a measured object.

Exemplarily, the measurement signal is an acoustic wave signal, electromagnetic wave signal, infrared signal and the like sent to the measured object by the terminal; and for example, the measurement signal may be an infrared signal sent by a proximity sensor on the terminal, or may also be an acoustic wave signal sent by an acoustic wave transceiver device on the terminal.

It is important to note that the terminal is usually operated by a user, so that in the embodiment, the measured object may be a body of the user or a certain part, such as a palm, of the body of the user.

In step 102: the terminal receives an echo signal.

Exemplarily, the echo signal is a signal obtained after the measurement signal is reflected by the measured object. And specifically, in Step 101, the terminal may send the measurement signal to a free space around the terminal, and since the measured object is located in the vicinity of the terminal, the measurement signal is reflected by the measured object to generate the echo signal.

In step 103: the terminal acquires a characteristic of the echo signal, and determines a player control instruction corresponding to the characteristic of the echo signal according to a preset corresponding relationship between the characteristic of the echo signal and the player control instruction.

Exemplarily, the echo signal may reflect a state of the measured object by virtue of own some signal characteristics, and the characteristic of the echo signal may include at least one of the following attributes: strength of the echo signal, a frequency of the echo signal and the like. For example, a difference between the frequency of the echo signal and a frequency of the measurement signal may reflect a movement trajectory of the measured object; and a change in the strength of the echo signal may reflect a distance state between the measured object and the terminal, for example, whether the measured object is far away from or close to the terminal.

Alternatively, the corresponding relationship between the characteristic of the echo signal and the player control instruction may be preset according to empirical data and a maximally probable situation where the characteristic of the echo signal appears.

Alternatively, when the difference occurs between the frequency of the echo signal and the frequency of the measurement signal, it is indicated that the measured object is in a moving state at this moment, and the terminal may determine the movement trajectory of the measured object according to a deviation between the frequency of the echo signal and the frequency of the measurement signal in combination with a Doppler effect and determine a player control instruction corresponding to the movement trajectory of the measured object according to the movement trajectory of the measured object and a preset corresponding relationship between the movement trajectory and the player control instruction.

For example, if the measured object is the body of the user and the movement trajectory of the measured object is moving far away from the terminal, a highly probable situation is that the user is required to temporally leave from the terminal, thereby it is necessary to change the player from a playing state into a pausing state, and the player control instruction in the situation is an instruction used to pause playing.

For another example, if the measured object is a hand of the user and the terminal determines that the movement trajectory of the measured object is upward and moving away from the player, a highly probable situation is that the user is required to answer the phone, thereby it is necessary to lower a playing volume of the player, and the player control instruction in the situation is an instruction used to lower the playing volume.

Alternatively, when the strength of the echo signal changes, it is indicated that the distance state between the measured object and the terminal changes, for example, the measured object may be in a state of getting close to or far away from the terminal, and the terminal may determine the distance state between the measured object and the terminal according to a change in the strength of the echo signal and determine a player control instruction corresponding to the distance state according to the distance state between the measured object and the terminal and the preset corresponding relationship between the distance state and the player control instruction.

For example, when the strength of the echo signal increases, it is indicated that the measured object is getting close to the terminal, and a highly probable situation is that the user is required to perform another operation on the terminal at this moment, thereby it is necessary to lower the playing volume of the player to avoid interference to the other operation of the user over the terminal, and the player control instruction in the situation is an instruction used to lower the playing volume.

For another example, when the strength of the echo signal decreases, it is indicated that the measured object is getting far away from the terminal, and a highly probable situation is that the user is required to temporally leave from the terminal at this moment, thereby it is necessary to change the playing state of the player into the pausing state, and the player control instruction in the situation may be a playing pausing instruction.

The above exemplary situations only describe the technical solutions of the embodiment of the present disclosure, and it may be understood that the other characteristics of the echo signal may also correspond to other situations, so that different corresponding playing states of the player are required. There are no elaborations and specific limits made in the embodiment.

In step 104: the terminal controls the player according to the player control instruction.

The embodiment provides the interaction method for the player, a behavior action of the measured object may be captured, and the playing state of the player may be automatically controlled according to the behavior action of the measured object, so that the playing state of the player may be controlled without manual operation.

On the basis of the embodiment shown in FIG. 1, FIG. 2 shows a detailed flow of an interaction method for a player according to an embodiment of the present disclosure, and in the embodiment, a terminal may be a tablet computer installed with the player, the player is initially in a playing state, a measured object is a hand of a user, and there are no specific limits made in the embodiment. A specific process of the interaction method of the embodiment may include the following steps: step 201, step 202, step 203 and step 204.

In step 201: the tablet computer sends a measurement signal to the hand of the user.

It is important to note that the measurement signal may be an infrared signal sent by a proximity sensor on the tablet computer, or may also be an acoustic wave signal sent by an acoustic wave transceiver device on the tablet computer and the like. And moreover, the tablet computer may send the measurement signal to a free space around it, and since the user is located in the vicinity of the tablet computer, the measurement signal may be reflected by the hand of the user to generate an echo signal.

In step 202: the tablet computer receives an echo signal.

It is important to note that the echo signal may reflect a state of the measured object by virtue of own some signal characteristics, and the characteristic of the echo signal is alternatively a frequency of the echo signal in the embodiment, so that the tablet computer may determine a current movement trajectory of the hand of the user through a difference between the frequency of the echo signal and a frequency of the measurement signal.

In step 203: the tablet computer may determine a current movement trajectory of the hand of the user by virtue of a difference between a frequency of the echo signal and a frequency of the measurement signal and determine a player control instruction corresponding to a characteristic of the echo signal according to a corresponding relationship between the movement trajectory and the player control instruction.

Exemplarily, when the hand of the user is raised by a relatively longer distance, for example, the user raises the hand from the tablet computer to the ear of the user, the user is very likely to answer the phone at this moment, thereby the tablet computer may determine that the user is to answer the phone when the movement trajectory of the hand of the user is upward movement by a relatively longer distance, for example, more than 70 cm; and at this moment, it is necessary to lower a playing volume of the player to avoid interference to the answering of the user to the phone, so that the player control instruction corresponding to the movement trajectory may be an instruction used to lower the playing volume.

In step 204: the tablet computer lowers a playing volume of the player according to an instruction used to lower the playing volume.

According to the detailed flow of the interaction method for the player provided by the embodiment, the movement trajectory of the hand of the user may be captured, and after it is determined that the user is to answer the phone according to the movement trajectory, the playing volume of the player is lowered by virtue of the instruction used to lower the playing volume, so that the playing volume of the player may be lowered without manual operation of the user.

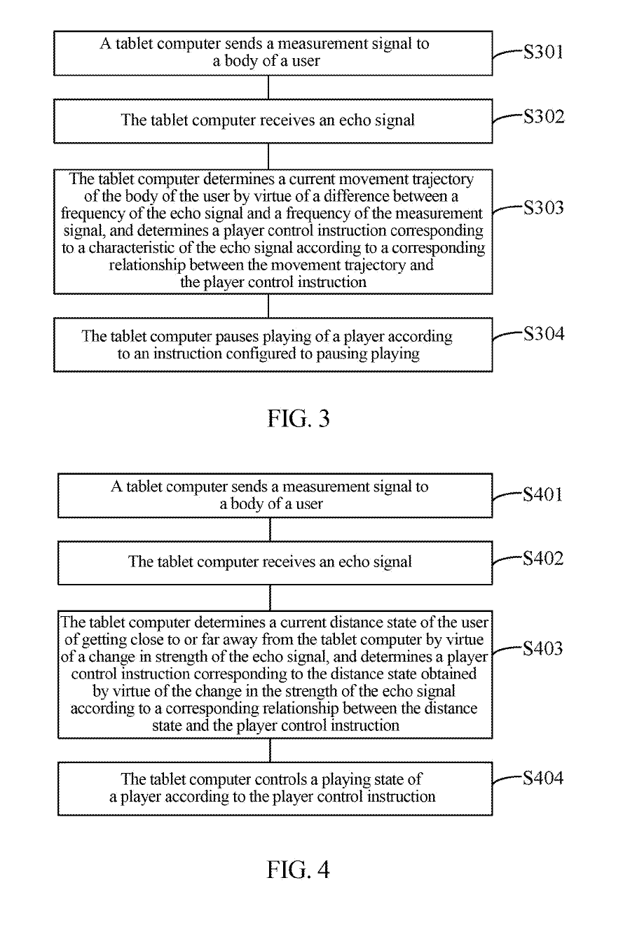

On the basis of the embodiment shown in FIG. 1, FIG. 3 shows another detailed flow of an interaction method for a player according to an embodiment of the present disclosure, and in the embodiment, a terminal may be a tablet computer installed with the player, the player is initially in a playing state, a measured object is a body of a user, and there are no specific limits made in the embodiment. A specific process of the interaction method of the embodiment may include the following steps: step 301, step 302, step 303 and step 304.

In step 301: the tablet computer sends a measurement signal to the body of the user.

It is important to note that the measurement signal may be an infrared signal sent by a proximity sensor on the tablet computer, or may also be an acoustic wave signal sent by an acoustic wave transceiver device on the tablet computer and the like. And moreover, the tablet computer may send the measurement signal to a free space around it, and since the user is located in the vicinity of the tablet computer, the measurement signal may be reflected by the body of the user to generate an echo signal.

In step 302: the tablet computer receives an echo signal.

It is important to note that the echo signal may reflect a state of the measured object by virtue of own some signal characteristics, and the characteristic of the echo signal is alternatively a frequency of the echo signal in the embodiment, so that the tablet computer may determine a current movement trajectory of the body of the user through a difference between the frequency of the echo signal and a frequency of the measurement signal.

In step 303: the tablet computer may determine a current movement trajectory of the body of the user by virtue of a difference between a frequency of the echo signal and a frequency of the measurement signal and determine a player control instruction corresponding to a characteristic of the echo signal according to a corresponding relationship between the movement trajectory and the player control instruction.

Exemplarily, when the movement trajectory of the body of the user is moving far away from the tablet computer, the user is very likely to temporally move away from the tablet computer; and therefore, the tablet computer may determine that the user is required to temporally leave, it is necessary to change the playing state of the player into a pausing state, and then the player control instruction corresponding to the movement trajectory, which is moving far away from the tablet computer, of the body of the user may be a playing pausing instruction.

In step 304: the tablet computer pauses playing of the player according to an instruction used to pause playing.

According to the detailed flow of the interaction method for the player provided by the embodiment, the movement trajectory of the body of the user may be captured, and after it is determined that the user is to temporally leave from the tablet computer according to the movement trajectory, playing of the player is paused by virtue of the instruction used to pausing playing, so that playing of the player may be paused without manual operation of the user.

On the basis of the embodiment shown in FIG. 1, FIG. 4 shows another detailed flow of an interaction method for a player according to an embodiment of the present disclosure, and in the embodiment, a terminal may be a tablet computer installed with the player, the player is initially in a playing state, a measured object is a body of a user, and there are no specific limits made in the embodiment. A specific process of the interaction method of the embodiment may include the following steps: step 401, step 402, step 403 and step 404.

In step 401: the tablet computer sends a measurement signal to the body of the user.

It is important to note that the measurement signal may be an infrared signal sent by a proximity sensor on the tablet computer, or may also be an acoustic wave signal sent by an acoustic wave transceiver device on the tablet computer and the like; and moreover, the tablet computer may send the measurement signal to a free space around it, and since the user is located in the vicinity of the tablet computer, the measurement signal may be reflected by the body of the user to generate an echo signal.

In step 402: the tablet computer receives an echo signal.

It is important to note that the echo signal may reflect a state of the measured object by virtue of own some signal characteristics, and the characteristic of the echo signal is alternatively strength of the echo signal in the embodiment, so that the tablet computer may determine whether the user currently gets close to or far away from the tablet computer or not through a change of the strength of the echo signal. For example, if the echo signal is strengthened, it is indicated that the user is getting close to the tablet computer; and if the echo signal is weakened, it is indicated that the user is getting far away from the tablet computer.

In step 403: the tablet computer may determine a current distance state of the user of getting close to or far away from the tablet computer by virtue of a change in the strength of the echo signal and determine a player control instruction corresponding to the distance state obtained by virtue of the change in the strength of the echo signal according to a corresponding relationship between the distance state and the player control instruction.

Exemplarily, when the strength of the echo signal increases, it is indicated that the user is getting close to the tablet computer, and the user is very likely to perform another operation on the tablet computer at this moment, thereby the tablet computer may determine that the user is required to perform the other operation, it is necessary to lower a playing volume of the player to avoid interference to the other operation of the user over the tablet computer, and the player control instruction corresponding to increase of the strength of the echo signal may be an instruction used to lower the playing volume.

Or, when the strength of the echo signal decreases, it is indicated that the user is getting far away from the tablet computer, and the user is very likely to temporally leave from the tablet computer at this moment, so that the tablet computer may determine that the user is required to temporally leave, it is necessary to change the playing state of the player into a pausing state, and then the player control instruction corresponding to decrease of the strength of the echo signal may be a playing pausing instruction.

In step 404: the tablet computer may control the playing state of the player according to the player control instruction.

Specifically, when the player control instruction is the instruction used to lower the playing volume, the tablet computer may lower the playing volume of the player.

When the player control instruction is the playing pausing instruction, the tablet computer pauses playing of the player.

According to the detailed flow of the interaction method for the player provided by the embodiment, the distance state between the user and the tablet computer may be captured, and the playing state of the player may be controlled according to the distance state, so that the playing state of the player may be controlled without manual operation of the user.

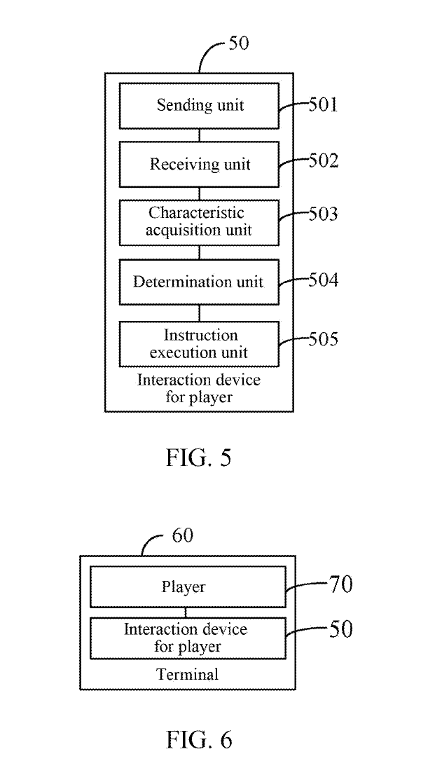

FIG. 5 shows a structure of an interaction device 50 for a player according to an embodiment of the present disclosure, the device 50 may be applied to a terminal installed with the player, and the device 50 may include: a sending unit 501, a receiving unit 502, a characteristic acquisition module 503, a determination unit 504 and an instruction execution unit 505.

The sending unit 501 sends a measurement signal to a measured object.

The receiving unit 502 receives an echo signal.

The characteristic acquisition unit 503 acquires a characteristic of the echo signal.

The determination unit 504 determines a player control instruction corresponding to the characteristic of the echo signal according to a preset corresponding relationship between the characteristic, acquired by the characteristic acquisition unit 503, of the echo signal and the player control instruction.

The instruction execution unit 505 controls the player according to the player control instruction.

Exemplarily, the measurement signal may be an acoustic wave signal, electromagnetic wave signal, infrared signal and the like sent to the measured object by the terminal. And for example, when the sending unit 501 is a proximity sensor, the measurement signal may be an infrared signal sent by the proximity sensor, or when the sending unit 501 is an acoustic wave transceiver device, the measurement signal may be an acoustic wave signal sent by the acoustic wave transceiver device.

It is important to note that the terminal is usually operated by a user, so that the measured object may be a body of the user or a certain part, such as a palm, of the body of the user in the embodiment.

The echo signal may be a signal obtained after the measurement signal is reflected by the measured object. And specifically, the sending unit 501 may send the measurement signal to a free space around the terminal, and since the measured object is located in the vicinity of the terminal, the measurement signal is reflected by the measured object to generate the echo signal.

Furthermore, the echo signal may reflect a state of the measured object by virtue of own some signal characteristics, and the characteristic of the echo signal may include at least one of the following attributes: strength of the echo signal, a frequency of the echo signal and the like. For example, a difference between the frequency of the echo signal and a frequency of the measurement signal may reflect a movement trajectory of the measured object; and a change of the strength of the echo signal may reflect a distance state between the measured object and the terminal, for example, whether the measured object is far away from or close to the terminal.

Furthermore, the corresponding relationship between the characteristic of the echo signal and the player control instruction may be preset according to empirical data and a maximally probable situation where the characteristic of the echo signal appears.

Alternatively, when the difference occurs between the frequency of the echo signal and the frequency of the measurement signal, it is indicated that the measured object is in a moving state at this moment, and the characteristic acquisition unit 503 may determine the movement trajectory of the measured object according to a deviation between the frequency of the echo signal and the frequency of the measurement signal in combination with a Doppler effect; and the determination unit 504 determines a player control instruction corresponding to the movement trajectory of the measured object according to the movement trajectory of the measured object and a preset corresponding relationship between the movement trajectory and the player control instruction.

For example, if the measured object is the body of the user and the characteristic acquisition unit 503 determines that the movement trajectory of the measured object is moving far away from the terminal, a highly probable situation is that the user is required to temporally leave from the terminal, so that it is necessary to change the player from a playing state into a pausing state, and the player control instruction determined by the determination unit 504 in the situation is an instruction used to pause playing.

For another example, if the measured object is a hand of the user and the characteristic acquisition unit 503 determines that the movement trajectory of the measured object is upward and moving away from the player, a highly probable situation is that the user is required to answer the phone, so that it is necessary to lower a playing volume of the player, and the player control instruction determined by the determination unit 504 in the situation is an instruction used to lower the playing volume.

Alternatively, when the strength of the echo signal changes, it is indicated that the distance state between the measured object and the terminal changes. For example, the measured object may be in a state of getting close to or far away from the terminal, and the characteristic acquisition unit 503 may determine the distance state between the measured object and the terminal according to a change of the strength of the echo signal. And the determination unit 504 determines a player control instruction corresponding to the distance state according to the distance state between the measured object and the terminal and the preset corresponding relationship between the distance state and the player control instruction.

For example, when the strength of the echo signal increases, it is indicated that the measured object is getting close to the terminal, and a highly probable situation is that the user is required to perform another operation on the terminal at this moment, so that it is necessary to lower the playing volume of the player to avoid interference to the other operation of the user over the terminal, and the player control instruction determined by the determination unit 504 in the situation is an instruction used to lower the playing volume.

For another example, when the strength of the echo signal decreases, it is indicated that the measured object is getting far away from the terminal, and a highly probable situation is that the user is required to temporally leave from the terminal at this moment, so that the characteristic acquisition unit 503 may determine that the user is required to temporally leave, it is necessary to change the playing state of the player into the pausing state, and the player control instruction determined by the determination unit 504 in the situation may be a playing pausing instruction.

According to the interaction device 50 for the player provided by the embodiment, a behavior action of the measured object may be captured, and the playing state of the player may be automatically controlled according to the behavior action of the measured object, so that the playing state of the player may be controlled without manual operation.

FIG. 6 shows a terminal 60 according to an embodiment of the present disclosure, and the terminal 60 is installed with a player 70, and may include the interaction device 50 for the player according to any one of the abovementioned embodiments.

An embodiment of the present disclosure further records a storage medium, in which a computer program is stored, herein the computer program executes the interaction method for the player in each of the abovementioned embodiments.

Those skilled the art should know that the embodiment of the present disclosure may be provided as a method, a system or a computer program product. Therefore, the present disclosure may adopt a form of pure hardware embodiment, pure software embodiment and combined software and hardware embodiment. Moreover, the present disclosure may adopt a form of computer program product implemented on one or more computer-available storage media (including, but not limited to, a disk memory and an optical memory) including computer-available program codes.

The present disclosure is described with reference to flowcharts and/or block diagrams of the method, equipment (system) and computer program product according to the embodiment of the present disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further be loaded onto the computer or the other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

The above is only the better embodiment of the present disclosure and not intended to limit the scope of patent of the present disclosure.

### INDUSTRIAL APPLICABILITY

According to the present disclosure, the behavior action of the measured object is captured, and the playing state of the player is automatically controlled according to the behavior action of the measured object, so that the playing state of the player may be controlled without manual operation.

What is claimed is:

1. An interaction method for a player, applied to a terminal installed with the player, comprising:
sending, by the terminal, a measurement signal to a measured object;
receiving, by the terminal, an echo signal, wherein the echo signal is a signal obtained after the measurement signal is reflected by the measured object;
acquiring, by the terminal, a characteristic of the echo signal, and determining a player control instruction corresponding to the characteristic of the echo signal according to a preset corresponding relationship between the characteristic of the echo signal and the player control instruction; and
controlling, by the terminal, the player according to the player control instruction.

2. The method according to claim 1, wherein the characteristic of the echo signal comprises at least one of following attributes: strength of the echo signal and a frequency of the echo signal.

3. The method according to claim 2, wherein, when the characteristic of the echo signal is the strength of the echo signal, determining the player control instruction corresponding to the characteristic of the echo signal according to the preset corresponding relationship between the characteristic of the echo signal and the player control instruction comprises:
when the strength of the echo signal changes, determining, by the terminal, a distance state between the measured object and the terminal according to a change of the strength of the echo signal; and
determining a player control instruction corresponding to the distance state according to the distance state between the measured object and the terminal and a preset corresponding relationship between the distance state and the player control instruction.

4. The method according to claim 2, wherein, when the characteristic of the echo signal is the frequency of the echo signal, determining the player control instruction corresponding to the characteristic of the echo signal according to the preset corresponding relationship between the characteristic of the echo signal and the player control instruction comprises:
determining, by the terminal, a movement trajectory of the measured object in combination according to a deviation between the frequency of the echo signal and a frequency of the measurement signal with a Doppler effect; and
determining, by the terminal, a player control instruction corresponding to the movement trajectory of the measured object according to the movement trajectory of the measured object and a preset corresponding relationship between the movement trajectory and the player control instruction.

5. An interaction device for a player, applied to a terminal installed with the player, the device comprising: a sending unit, a receiving unit, a characteristic acquisition unit, a determination unit and an instruction execution unit, wherein
the sending unit sends a measurement signal to a measured object;
the receiving unit receives an echo signal, wherein the echo signal is a signal obtained after the measurement signal is reflected by the measured object;
the characteristic acquisition unit acquires a characteristic of the echo signal;
the determination unit determines a player control instruction corresponding to the characteristic of the echo signal according to a preset corresponding relationship between the characteristic of the echo signal acquired by the characteristic acquisition unit and the player control instruction; and
the instruction execution unit controls the player according to the player control instruction.

6. The device according to claim 5, wherein the characteristic of the echo signal comprises at least one of following attributes: strength of the echo signal and a frequency of the echo signal.

7. The device according to claim 6, wherein, when the characteristic of the echo signal is the strength of the echo signal,
the characteristic acquisition unit, when the strength of the echo signal changes, determines a distance state between the measured object and the terminal according to a change in the strength of the echo signal; and
the determination unit determines a player control instruction corresponding to the distance state according to the distance state between the measured object and the terminal and a preset corresponding relationship between the distance state and the player control instruction.

8. The device according to claim 6, wherein, when the characteristic of the echo signal is the frequency of the echo signal,
the characteristic acquisition unit determines a movement trajectory of the measured object according to a deviation between the frequency of the echo signal and a frequency of the measurement signal in combination with a Doppler effect; and
the determination unit determines a player control instruction corresponding to the movement trajectory of the measured object according to the movement trajectory of the measured object and a preset corresponding relationship between the movement trajectory and the player control instruction.

9. A terminal, installed with a player and comprising the interaction device for the player according to claim 5.

10. A storage medium, storing a computer program, wherein the computer program executes the interaction method for the player according to claim 1.

11. A terminal, installed with a player and comprising the interaction device for the player according to claim 6.

12. A terminal, installed with a player and comprising the interaction device for the player according to claim 7.

13. A terminal, installed with a player and comprising the interaction device for the player according to claim 8.

14. A storage medium, storing a computer program, wherein the computer program executes the interaction method for the player according to claim 2.

15. A storage medium, storing a computer program, wherein the computer program executes the interaction method for the player according to claim 3.

16. A storage medium, storing a computer program, wherein the computer program executes the interaction method for the player according to claim 4.
